(19) United States
(12) Patent Application Publication
(10) Pub. No.: US 2005/0289056 A1
(43) Pub. Date: Dec. 29, 2005

(54) Player tracking system

(76) Inventor: Robert Guinn, Henderson, NV (US)

Correspondence Address: Morishita Law Firm, L.L.C., Suite 850, 3800 Howard Hughes Pkwy., Las Vegas, NV, 89109, US

(21) Appl. No.: 11/216,714

(22) Filed: Aug. 31, 2005

Related U.S. Application Data
(63) Continuation-in-part of application No. 10/809,536, filed on Mar. 24, 2004.
(60) Provisional application No. 60/458,852, filed on Mar. 27, 2003.

(51) Int. Cl. G06Q 40/00

(52) U.S. Cl. 705/43; 705/14

(57) ABSTRACT

This invention is a system for transmitting and recording the transfer of electronic funds to and from a plurality of transaction nodes where such transaction nodes are of a heterogeneous nature, and may include personal data units as well as such units such as ATM machines, POS devices, check cashing systems, player tracking systems, electronic marker systems, and manual input devices. Such transactions are recorded against a central transaction and information database. Upon request, accumulated credit may be dispensed via a secure cash distribution system, and when necessary the replenishment of said cash distribution system will be automatically performed. The system also may include an automated replenishment point, such as a casino shift change.

### RELATED APPLICATION DATA

The present application is a continuation-in-part of U.S. patent application Ser. No. 10/809,536, entitled “Player Tracking System,” filed Mar. 24, 2004 which, in turn, claimed the priority of U.S. Provisional Application Ser. No. 60/458,852, entitled “Player Tracking System,” filed Mar. 27, 2003 by Applicants herein.

### FIELD OF THE INVENTION

The present invention relates to an electronic funds and data management system and apparatus for the secure storage, retrieval, transmission and tracking of electronic funds, transactions, and customer data, in a heterogeneous network. Specifically, the present invention recites a system and method for dispensing money from a cash bank, and replenishing money from a cash bank to an electronic safe, wherein input and dispensing devices may each be of multiple device types.

### BACKGROUND OF THE INVENTION

Casinos frequently implement player tracking systems to track the wagering history of players, to award points or “comps,” (e.g., coupons for discounted meals, drinks, shows, rooms, etc.) based on the level of wagering, and to generally promote the casino by enticing players to return to the casino in order to accumulate more points and comps. Presently it is typical for a player to be issued a plastic card that has an embedded magnetic stripe on which a player identification number is encoded. The player inserts the card into a magnetic reading device located on slot machines or other games in the casino in order to identify the player during the time that the card is inserted in the reader. Some systems require the player to enter a PIN to identify themselves through a keypad. The readers are generally linked to a local computer system that records the gaming activity for each player that uses a card. Some systems link local systems so that information can be available at different locations, although these systems generally do not centralize the information, but instead maintain the information in a distributed fashion at each location.

Despite the widespread use of magnetic card systems for player tracking, these systems have several drawbacks. Card readers tend to require considerable maintenance because of the mechanical parts used in receiving and expelling cards. Cards also tend to get lost, primarily because players forget to take them when they leave a game. Finally, a player that just wants to quickly play a game is discouraged from using his or her magnetic card in that it takes time to use the card: the player has to take the card out of his/her wallet, insert the card, wait for the card to be accepted, enter a PIN, and finally begin play.

Additionally, there is no comprehensive system that controls and tracks the dispensing of cash. There are systems such as cash registers and ATM machines for storing and enabling the dispensing of pay outs at locations. In such known systems, the pay outs and dispensing methods are based largely on single depletion methods such as issuing change to a customer or receiving cash from an ATM machine, for instance. Typically, a retail outlet or restaurant/bar would replenish their depletion of cash from the acceptance of checks, IOU's, vouchers, games, and coupons from their bank account on the next business day. It has become increasingly tedious to account for and manually reconcile these types of depletion methods. Also, it has been known for locations such as convenience stores to utilize a safe for dispensing small sums of cash over a period of time such that the liability of theft at these locations are kept to a minimum, because the control of allowing excess cash to be withdrawn from the safe increases the theft liability. The drawback to this method is the inconvenience caused when cash required from the safe exceeds the time parameters for cash dispensing which results in delays from getting change to customers.

In other described methods for dispensing cash through a safe such as U.S. Pat. No. 6,763,998, the claims are based upon individual events occurring at the locations through a single transaction at a gaming device, and further based upon an attendant being the interface between the events. Although these cash dispensing methods may be beneficial for security, there are drawbacks to dispensing the cash too often, with always having the attendant involved with the transaction. Further, the methods do not disclose the ability of handling multiple inputs that affect the need for dispensing cash. In the methods enclosed, the safe dispenses cash at specific trigger intervals such as shift end or thresholds based on accumulating the multiple debit methods. This results in less labor at the location where the safe resides, less wear and tear on the moving mechanisms within the safe, and less transactions to audit at the safe. As more types of systems are deployed; such as coupons for Point of Sale food and beverage, free play coupons for gaming machines, marker systems for short term loans to customers, and the like, it becomes increasingly necessary to utilize a safe dispensing system that has accommodations for all of these cash depletion methods whereby all of the depletion methods can be combined and audited for secure cash replenishment.

### SUMMARY OF THE INVENTION

A player tracking system is described herein that utilizes an RF device to carry a player identification number instead of a magnetic stripe card. In general, a system and method in an embodiment of the invention includes a small plastic fob containing a radio frequency (RF) antenna and an embedded identifier. The fob transmits a signal that is received by one of a plurality of games or other interactive devices having associated circuitry installed which recognizes the identifier and thus identifies the player who holds the fob. Several discrete remote gaming locations are connected to a central location where player information is stored and maintained in a database. When a player scans his fob at a game at any remote location connected to the central location, the identifier is transmitted to the central location and the player information is transmitted to the game. The player can begin play, accumulating points on his/her account reflective of his or her gaming activity. Points are accumulated based on the level of wagering and/or winning, based on awards or marketing promotions, or by any other method determined by the gaming establishment. Comps can also be awarded and recorded in the player's account. Points, in some embodiments, have a monetary value, and the player can redeem points for cash at the game itself without third-party assistance.

Enrollment of players in a tracking system in an embodiment of the invention can also be accomplished at a gaming or other interactive device that is part of the system. In one embodiment, an enroll signal is entered at the device, typically by a button, and then a fob held by the individual is scanned. A PIN is entered by the individual and the identifier and PIN are transmitted to the central site.

Finally, a system in an embodiment of the invention generates a plurality of reports at the central site which are viewable at the remote sites. In some embodiments the reports are viewable over an Internet connection. In one embodiment, one of the reports allows a user to view the activity of a player in real time.

By using an RF fob in some embodiments, there is less maintenance required for readers, a player can more quickly initiate play while accumulating points, and loss of fobs is lower than with magnetic cards, since the fobs are not inserted into a reader but kept on the player's person.

In an extension of the present invention, the present invention also includes a system for tracking cash transactions and dispensing cash, as well as transferring cash between a safe cash dispenser and a cash drawer. In such an optional embodiment, a cash reconciliation and secure cash replenishment system includes a computer communicating with a computer network that stores a transaction and information database. A cash dispenser communicating with the computer network includes a secure cash safe storing cash and a cash drawer receiving cash from the secure cash safe and dispensing cash.

According to the present invention, a plurality of transaction nodes, each of which communicate with the computer network, receive transaction input identifying a transaction amount. When transaction input received at one of the transaction nodes is transmitted to the computer, the computer records the transaction at the transaction and information database and triggers the dispensing of cash from the cash dispenser in accordance with the transaction input. In an optional embodiment, the computer stores a tag identifier database and each transaction input includes a tag identifier received, for example, from a fob (described above). In such an optional embodiment, before triggering the dispensing of cash at the cash dispenser, the computer validates the transaction input by comparing the tag identifier to the tag identifier database.

It is contemplated that the transaction input may come in a variety of different forms including: (a) a manual input for manually entering transactions against the transaction and information database, (b) an electronic input for entering electronic transactions against the transaction and information database, (c) a computer input for entering electronic transactions against the transaction and information database through a point of sale system, (d) a computer input for entering electronic transactions against the transaction and information database through an electronic check cashing system, (e) a computer input for entering electronic transactions against the transaction and information database through a credit card system, (f) a computer input for entering electronic transactions against the transaction and information database through a debit card system, (g) a computer input for entering electronic transactions against the transaction and information database through a credit marker system, (h) a computer input for entering electronic transactions against the transaction and information database through an online accounting system, (i) a computer input for entering electronic transactions against the transaction and information database through a radio frequency identifier device, and (j) a computer input for entering manual transactions against the transaction and information database through an interface.

The present invention also serves to move cash from the cash safe to the cash drawer. The conditions causing the computer to trigger the transfer of cash from the cash safe to the cash drawer could take many different forms, including a specific time such as a fixed employee shift change time, the depletion of the cash in the cash drawer below a predetermined balance, or the like.

The system may further include an auditing and reporting system communicating with the computer network. The auditing and reporting system includes an output device. The auditing and reporting system receives data from the computer network identifying, for each transaction input, the transaction node at which the transaction input was received and the transaction amount and outputs the data at the output device

The present method and system allows for secure replenishment by taking into account electronically the various debit transactions that occur through both manual and electronic interfaces, which are much more reliable than the timed methods.

### BRIEF DESCRIPTION OF THE DRAWINGS

FIG. 1 is a generalized function block diagram of a system in an embodiment of the invention;

FIG. 2 is a generalized function block diagram of an RF enclosure in an embodiment of the invention;

FIG. 3 is an exemplary keypad in an embodiment of the invention;

FIG. 4 is a flow diagram showing steps for initializing fobs and associating fobs with a player in an embodiment of the invention;

FIG. 5 is a flow diagram showing steps for enrolling players in an embodiment of the invention;

FIG. 6 is a flow diagram showing steps for player login and logout in an embodiment of the invention;

FIG. 7 is a flow diagram showing steps for point redemption in an embodiment of the invention;

FIG. 8 shows a block diagram of a heterogenous network of dispensing and receiving devices interfacing with a common central computer system; and

FIG. 9 shows a functional decomposition of a heterogeneous network capable of receiving and dispensing cash and credit, to or from, a common safe bank.

### DESCRIPTION

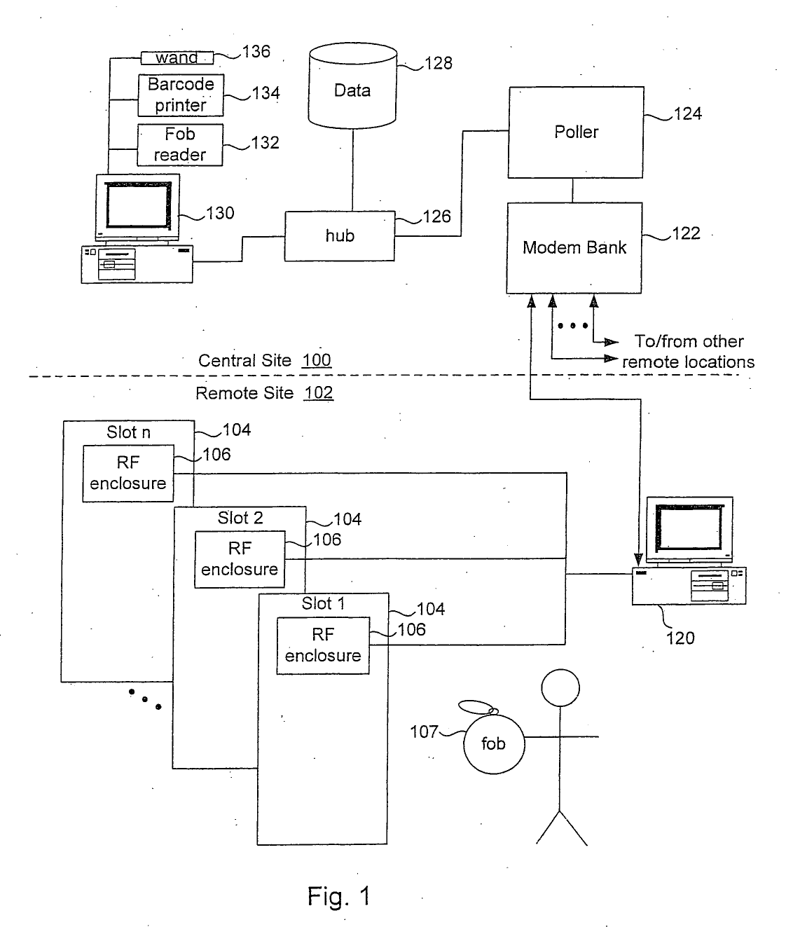

Reference is now made to the figures wherein like parts are referred to by like numerals throughout. An embodiment in accordance with the invention is illustrated in FIG. 1 and spans at least two locations: central site 100 and remote site 102. Generally, remote site 102 will not be the same physical location as central site, although in some embodiments it can be. In addition, although not shown for simplicity of illustration, multiple remote sites are contemplated in various embodiments of the invention.

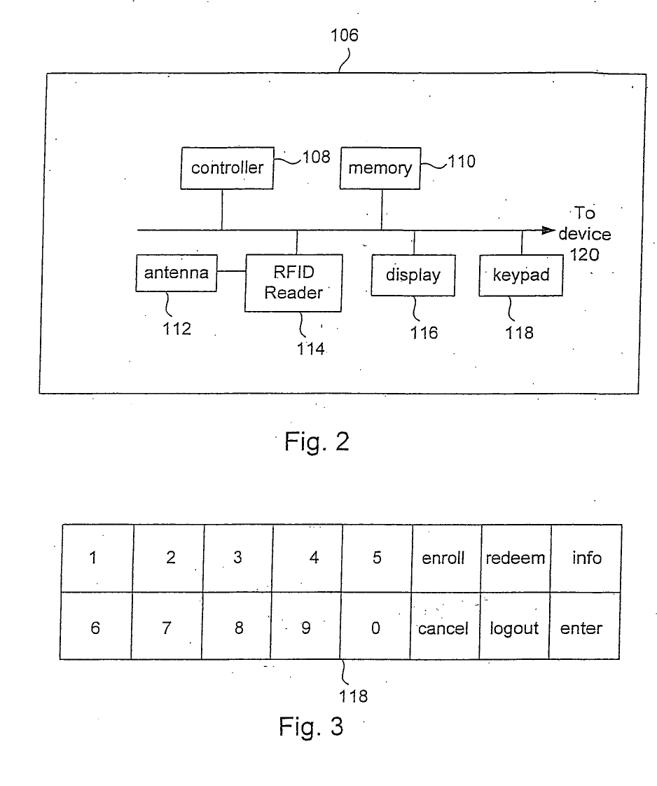

Remote site 102 includes one or more slot machines 104, Slots 1 . . . n. An RF enclosure 106 is mounted on or otherwise coupled to each slot machine 104. Referring to FIG. 2, each RF enclosure 106 includes a controller 108, a memory 110, an antenna 112, an RF ID reader 114, a display 116, and a keypad 118. In one embodiment, the controller 108 and memory 110 are a single integrated structure, which in one embodiment is an ATMega128 or ATMega161, both available from Atme1 of San Jose, Calif. RF ID reader 114 in one embodiment is Read/Write Base Station U2270B, also available from Atme1, which is coupled to antenna 112, sometimes referred to as a “coil.” Although display 116 and keypad 118 are shown separately in FIG. 2, they can be embodied in an integrated unit, such as a touch screen.

FIG. 3 illustrates a keypad 118 in one embodiment of the invention. As illustrated, keypad includes ten number keys, along with keys entitled “enroll,” “redeem,” “info,” “cancel,” “logout,” and “enter.”

Referring again to FIG. 1, RF enclosure 106 is designed to interact with individual fobs 107 held by individual players. In one embodiment, each fob is approximately 40 mm in diameter and has an exterior housing made of plastic. Fob 107 includes an RF read only transponder that carries an identifier, which in one embodiment is the H4102 available from EM Microelectronic-Marin SA of Switzerland. When fob 107 is placed in proximity to RF ID reader 114, RF ID reader obtains the player identifier from the fob. This player identifier is then utilized as a unique identifier that is coupled to the play on the gaming machine 104.

Each RF enclosure 106 is coupled to a computing device 120 at remote site 102. In one embodiment, each RF enclosure 106 is coupled to computing device 120 using RS485-based connections. In one embodiment, computing device 120 is a PC running Windows 2000 or Windows XP and further includes a 1 Ghz processor, 256 Mb RAM, a 40 MB hard drive, a 56 kB modem, and a RS485-to-RS232 adapter. In one embodiment, computing device 120 further includes a browser such as Internet Explorer 5.0. Nonetheless, some embodiments do not include a browser and do not even require a display with computing device 120. As should be understood, the elements of computing device 120 described are exemplary only and many alternatives will be readily apparent to those of skill in the art. For instance, rather than a Windows-based PC, a MAC, a Linux-base device, a UNIX-based device, or other computing device can be used. As well, a broadband connection or leased line can be used instead of a 56 k modem. Moreover, elements of computing device 120 can also be of differing speeds or sizes in other embodiments. Computing device 120 is sometimes referred to herein as a “Data Control Unit” or “DCU.”

DCU 120 will at least periodically establish a connection with a modem bank 122 at central site 100. Modem bank 122 includes a dedicated modem for each remote site 102 (only one remote site is shown). In some embodiments for security purposes, modems at both the central site and remote sites will only accept an incoming call from a pre-assigned phone number (i.e., that of the remote site or central site). Modem bank 122 is coupled to a computing device 124 that receives data from all remote locations and is described in further detail below. Computing device 124, a Windows-based application, is sometimes referred to herein as a “Poller.”

Poller 124 is coupled to hub 126, which in turn is coupled to database 128, which in one embodiment runs Microsoft SQL Server 2000, although other embodiments may run other database software. Hub 126 is further coupled to computing device 130. Computing device 130 is the main administrative interface to the system of FIG. 1 and is therefore sometimes referred to herein as Admin-Manager device 130. In one embodiment, Admin-Manager device 130 is a PC running Windows 2000, although non-Windows PCs or computing devices are also suitable in other embodiments. Although only one device is shown for device 130, in some embodiments, multiple computing devices may be used to carry out its functionality, e.g, one device for administrative functions, one for management functions, and one for data entry. Further coupled to computing device 130 are fob reader 132, barcode printer 134, and barcode wand 136.

Admin-Manager device 130 further includes software modules to support an Administration function, a Management function, and a Reporting function.

The Administration module is used to manage system user access for the central site employees as well as the owners and managers of the various remote locations where the system is deployed. A user-administrator is responsible for setting up new users and user groups as well as removing users, e.g., when an employee leaves the company. Information is stored for each remote site, including address phone numbers, and contact information.

At least two categories of users are established in one embodiment: owners/managers of remote locations and “bar hosts.” Bar hosts, unless they are also an owner or manager, normally do not have privileges to use any of the system functions and are not granted system access. However, bar hosts are assigned “employee fobs” for the purpose of enrolling new players, as will be described below. The Management module acts as the primary user interface to the player tracking system. Access privileges to the various functions of the program are granted through the administration module. The management module manages player accounts, including adding, editing, disabling, and deleting accounts. The management module also manages fobs including initializing, verifying, processing, registering, enabling and disabling fobs. The management module further accounts for slot machines at the various remote locations, including adding, deleting, and moving slot machines, provides EFT (Electronic Funds Transfer) meter information for use by other accounting systems, allows game meter information to be viewed for problem resolution, shows transaction histories on various slot machines, and includes system set up parameters.

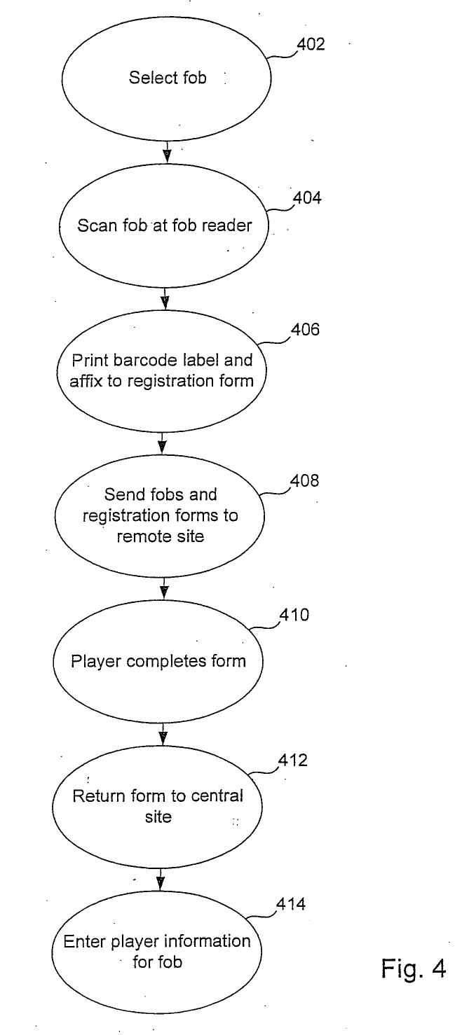

Fob registration is done using the manager module on device 130, which registration must occur before a fob can be issued to a player. Referring to FIG. 4, to register a fob, first an un-initialized fob is selected, step 402 and is read by a fob reader 132, step 404, which reads in an identifier stored on the fob and stores the identifier. This, in part, ensures that un-assigned third party fobs will be rejected from the system in case there is an unauthorized use of the fob. A barcode is created representative of the identifier on the fob, and a barcode label for the fob is printed on printer 134, step 406. The barcode label is attached to a registration form to be filled out by a new player. The fob and the registration form are then stored together, e.g., in a plastic bag: since the barcode identifies the fob, the player must fill in the registration form having the appropriate barcode label on it in order to be associated with the fob. Once initialized, the fobs (along with their associated registration forms) are sent to the remote location(s), step 408. New players who wish to join a gaming establishment's “club” will fill out a registration form, step 410. Once the form is completed, the player will be provided the fob associated with the form. The form is returned to the central site, step 412.

When the central site receives the registration from, it enters the player information using the management module, step 414. In particular, the user enters the information from the form into appropriate fields displayed on device 130. The program then prompts the user for the barcode on the registration form. The user scans the barcode on the form using wand 136, thereby matching the fob to the user's account. Any play that has been recorded for the player while using the fob before the player information was entered at the central site will be associated with the new account and the player will now be able to redeem player points for cash at any game that is connected to the central site.

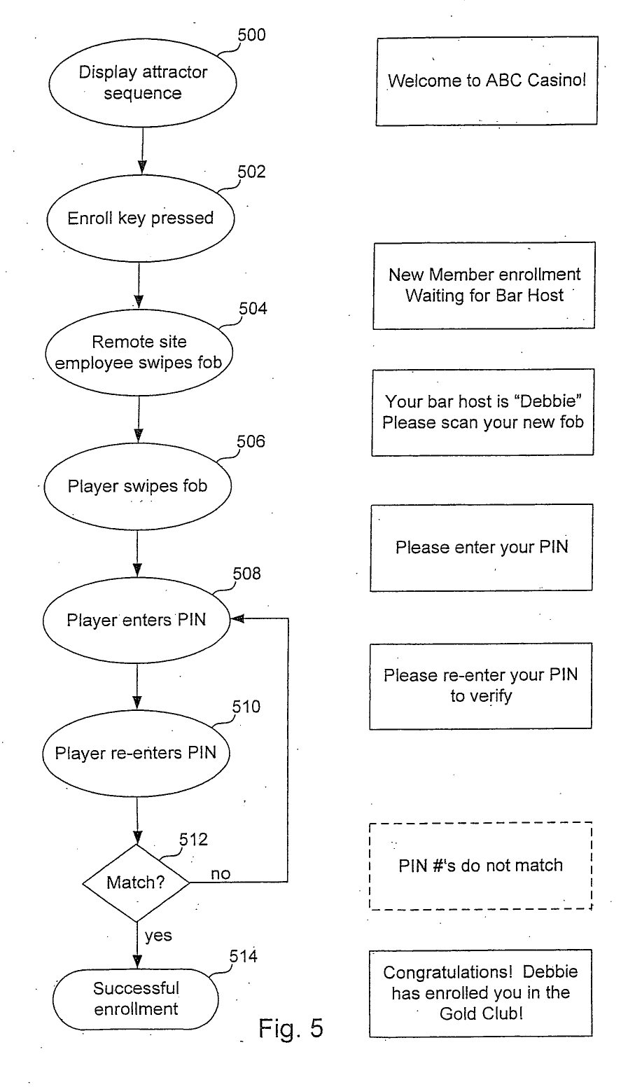

As soon as the player receives the fob at the remote site, the player can begin to use it for accumulating points even though all of his/her specific information has not yet been entered in the database at the central site. Referring to FIG. 5, to do so, the “enroll” button on a machine is pressed, step 502. A message is displayed on the display indicating that the bar host needs to swipe his/her fob: “New member enrollment . . . Waiting for Bar Host.” An employee at the remote site will then swipe an “employee fob” across the reader, step 504. A message is then displayed in one embodiment indicating that the player should swipe his/her fob: “Your bar host is ‘Debbie’. . . Please scan your new fob.” The player then swipes his/her new fob across the reader, step 506. The player will then be prompted on the display to enter a PIN, at which point the player enters a PIN using the keypad 118, step 508. The player will be prompted to re-enter the PIN for verification, step 510. If the entered and re-entered PINs do not match, step 512, the player is prompted to enter and re-enter his/her PIN again if the entered and re-entered PINs match, the player has been successfully enrolled, step 514. The player is now ready to accumulate points although the player will not be eligible, in some embodiments, to cash out the points until the player information is entered at the central site. In some embodiments, if at any time during the enrollment process there is more than a 30 second pause between actions, the enrollment process will be discontinued. In some embodiments, if the player or the employee wish to discontinue the process, the “enrol!” key is pressed again to stop the process.

Once enrolled, to accumulate points while playing games, the player swipes his/her fob across the area on the reader unit where the RF coil is located, step 602. The identifier is transmitted from the fob to the antenna 112 and RF ID reader 114 and then transmitted from the RF enclosure 106 to the central site through DCU 120, step 604. The central site database is searched using the identifier to find the player's name and point balance, step 606. While the player information is retrieved, the display displays a message such as “Searching for Files.” Once the player information is found, the player information in transmitted to the remote site, and a greeting is displayed to the player, e.g., “Hello Nancy! You have 198,340 points”. If no player is found, but the fob is valid, then only the player's points are displayed, e.g., “Hello Player! You have 108 points.” Player information may not be found if the player has recently enrolled and the player's information has not yet been entered at the central site. Although some embodiments only display the player's point balance other embodiments may display other elements of the player's account, such as whether the player has any comps or comps that are available for redemption.

Once successfully logged in, the player will typically go on to play the game, 610. When finished playing, the player presses the “logout” key on the keypad 118, step 612. The player's session points will be displayed along with a logout message in some embodiments, step 614. In addition, the system will automatically log out the player after a period of inactivity (e.g., 1 minute) or when a new player swipes a fob across the reader. The player's activity for each session from login to logout is recorded at the central site typically in the form of a point or account balance, although additional information can be stored such as the length of time the player played, how much money was wagered, and what game was played.

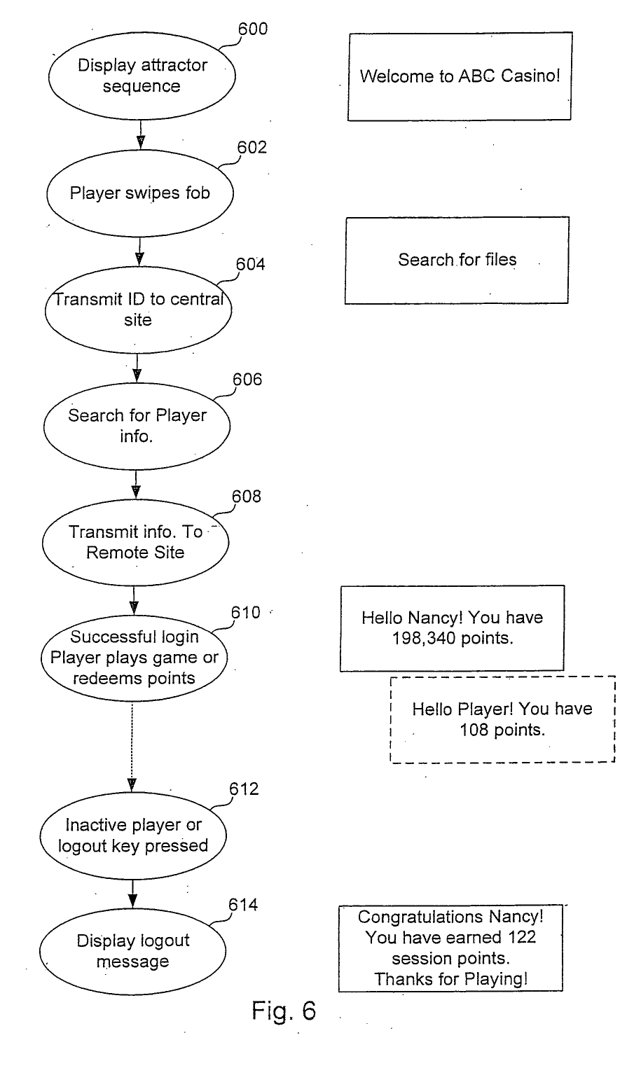

When a player is not playing a game, display 116 displays one or more attract messages, e.g., “Welcome to ABC Casino!,” as shown in steps 500 (FIG. 5) and 600 (FIG. 6).

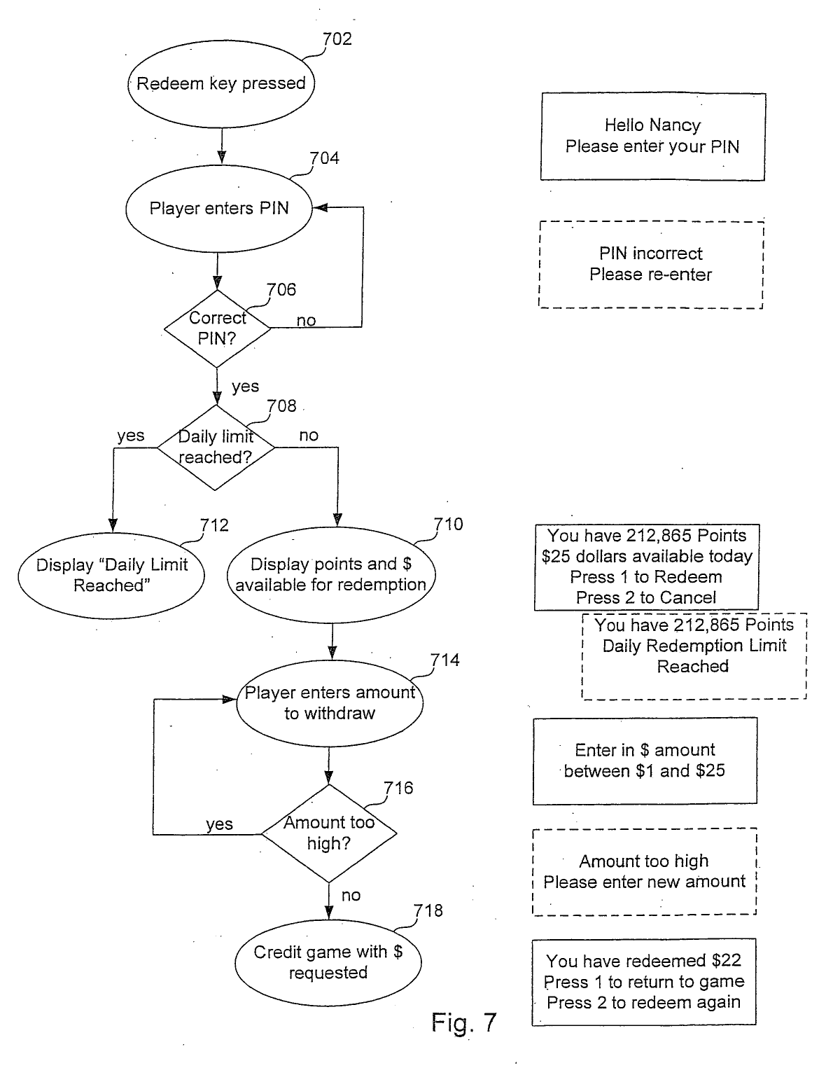

After a successful login, the player may choose to redeem points, FIG. 7, and can do so without the assistance of any remote location employees or other third parties. Pressing the “redeem” key on the keypad begins the redemption process, step 702. In order to redeem points, the player will be prompted by the system to enter his/her PIN on the keypad, step 704. Using a PIN provides additional security. The PIN is checked for accuracy, step 706, In some embodiments, there may be a daily limit on the amount that can be redeemed by the player, e.g., $25.00. If there is a daily limit, then in some embodiments the player's account is checked to see if the player has redeemed his/her daily limit, step 708. Some embodiments will not have a daily limit or will have a daily limit set to the total monetary value of the accumulated points. In some embodiments, the player is displayed his/her total points and available balance for redemption, step 710. But if a daily limit for redemption has been reached, the display notifies the player that he/she will be unable to redeem additional points, step 712. If the player has a redemption balance available, the player is prompted to key in a dollar amount to redeem, step 714. If the player has an adequate available balance, the system will credit the electronic funds transfer (EFT) meter in the gaming device for the amount requested, step 718. If the amount keyed in by the player is too high, however, the player will be informed that the amount it too high and asked to enter a new amount, step 716. Once the points are redeemed, the player can then choose to either cash out the credits, that have been downloaded to the game by pressing the “cash out” key typically available on slot machines, or the player can simply continue playing the game using the credits that were downloaded.

In addition to an Administration Module and a Management Module, Admin-Management device 130 also includes a Reporting Module in some embodiments. With the reporting module, various reports can be created. Reports can be accessed only by those having privileges to access reports—generally only those users whose job descriptions require access (access privileges are assigned with the Administration Module). Reports are generated at central site 100 since almost all player information is stored in database 128 and not at remote locations. In some embodiments, some reports are available over an Internet connection for those users at remote sites, but users will be required to log in and have appropriate privileges to be granted report access. Reports that are able to be generated in one embodiment include: user access reports showing access privileges for all users of the system; audit reports showing actions taken by users when logged into the system; redemption reports on a game-by-game basis; slot listing reports showing detailed information about games installed at each remote location, e.g., manufacturer, slot identifier number; parameter listing reports showing system parameters usually set up on system installation; liability reports showing a summary of outstanding player point values and the cash value of those points; meter consistency reports which show if games having meters that are incrementing outside of a reasonable predetermined rate; enrollment reports showing the number of newly enrolled players at various remote locations; comp detail reports showing the number and average value of comps given to players at selected remote locations; redemption detail reports showing point redemptions made at selected remote locations; version reports showing modifications and upgrades to the system; theoretical win reports showing player activity according to theoretical win per trip per gaming location; player history reports showing a detailed history per day for each location for each player; card/non-carded reports indicates the amount of coin-in per location that was played by logged-in players versus non-logged players; zip code reports shows the amount of coin-in, theoretical win, and actual win that a remote location produces from its enrolled players by zip code; and other various reports.

In addition, an embodiment of the invention can generate current player reports showing statistics regarding the activity of each currently logged-in player by location and in real time. These real-time reports are viewable in some embodiments by authorized users at remote locations on an Internet connection to the central location.

The remote site and the central site communicate using the poller and the DCU. The poller and the DCU each include software programs that place information into (and take information out of) the communication packets used for communicating between the sites.

Each packet utilizes a series of commands or bytes which are utilized as commands for the receiving application to decipher and by which the receiving application can decode and route or respond based on the deciphered message. “STX” and “ETV indicate the start and end of a packet. “Destination Address” and “Source Address” indicate the locations the packet is going to and the location that it came from. If a message is to be broadcast to, e.g., all remote locations from the central location the destination address is set to zero. “Category” and “Code” describe the class and category of messages. “Date Time” indicates the date and time the message was sent as is known in the art. “Logical Data Length” is the length of the data field. It is indicated as “logical” because in some embodiments, the physical data length may be different. For instance, in some embodiments, if the data field contains 0×55 or 0×AA, when the message is sent physically, these bytes are duplicated, e.g., if logical data is 0×55 0×AA, then the data physically sent is 0×55 0×55 0×AA 0×AA. The Logical Data Length does not include the duplicated bytes. “Data” contains any data being sent as will be described with the discussion of Categories and Codes.

Finally a CRC (Cyclical Redundancy Check) is used on the packet to further ensure the data send is accurate and not changed while in transit. CRC functions are well known in the art and any CRC function can be used. In one embodiment, however, the following CRC function is used:

UINT16 compute_CRC(UINT8 *s, UINT32 len, UINT16 crcva1)

```
UINT16 compute_CRC(UINT8 *s, UINT32len, UINT16 crcval)
{ UINT32 c;
      UINT32 q;
      UINT32 i;
      for(i = len;i > O:i−){
          c = *s++;
          q = (crcval\hat{ }c) & 0x0F;
          crcval = (crcva>>4) \hat{ } (q * 0x1081);
          q = (crcval \hat{ } (c>>4)) & 0x0F;
          crcval = (crcva>>4) \hat{ } (q * 0x1081); }
      return crcval; }
```

The “Category” and “Code” fields of each packet indicate the information that is being conveyed.

Accordingly a system and method have been described that provides a small RF identifying device that can simply be scanned and does not need to be inserted into a reader or otherwise leave the hands of the player. Although slot machines have been discussed as exemplary herein, it is to be understood, that various embodiments of the invention could be applied to other types of stand-alone games as well as gaming tables, and all are generally referred to herein as “gaming devices.” In addition, as should be understood, RF readers may also be established at kiosks, e.g., to check or redeem points, or at pay stations in restaurants, bars, gift shops, or other establishments, where the kiosks and pay stations are for tracking expenditures, accumulating points as a result of expenditures, or for redeeming points and comps. RF readers may also be used at sports wagering kiosks to redeem points for placing sports bets and to allow the accumulation of points when a player places sports bets. Accordingly, gaming devices, kiosks, and pay stations are all referred to generally herein as “interactive devices” and all generally share the characteristic that they are interactive with the player. Moreover, although an embodiment of the system as described herein is for recognizing players in a casino-type gaming environment, other embodiments are contemplated for other environments, including employee time management and building security.

Some advantages of using a fob include lower maintenance cost for the casino as the mechanical card reader is eliminated, greater player satisfaction because the fob is approximately 75% smaller than a magnetic card and can be comfortably attached to a key chain in some embodiments, faster access to player accounts as the player need only swipe the fob across the RF reader without using a key pad to actuate the system, and there is also a lower risk of loss of the fob because, unlike a magnetic card, it is not inserted into a reader for the entire time of play but rather kept on the player's person.

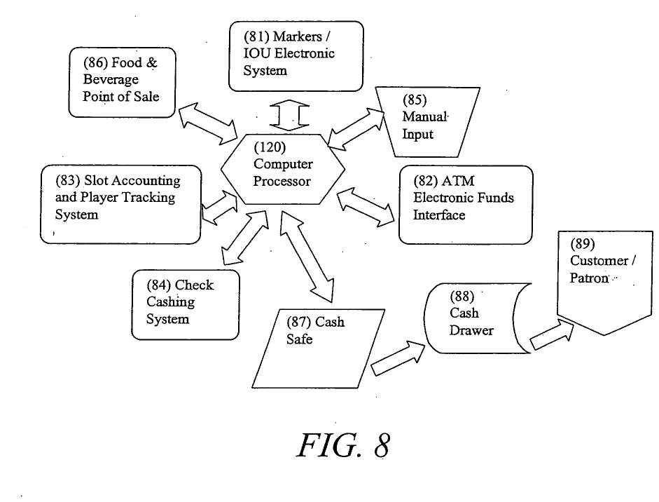

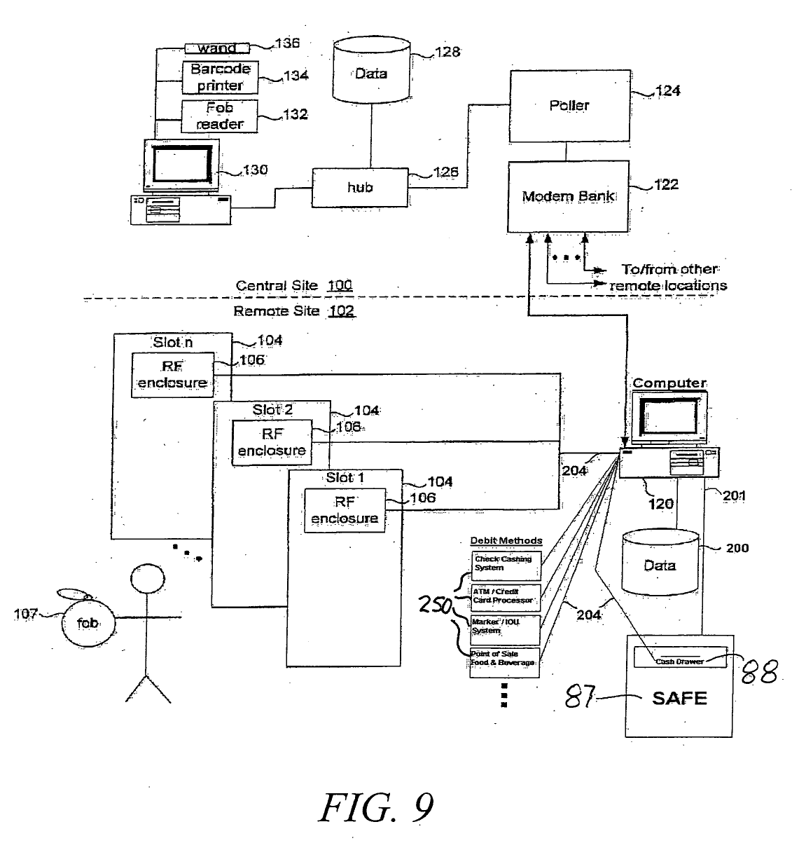

As shown in FIGS. 8 and 9, in a further optional embodiment, the system and method of the present invention may include a central computer 120 and a transaction and information database accessible to the central computer 120 such as at a data storage 200. In such an optional embodiment, the central computer 120, a cash dispenser (described in greater detail below), and a plurality of transaction nodes 250 of different varieties 81-89 communicate with one another, such as through a computer network. The transaction nodes 250 could take many different forms and may include one or more of: a marker/IOU electronic system 81, such as may be found in a gaming environment; an ATM machine 82 for obtaining cash; a slot accounting or player tracking system 83 such as is employed in many casinos for rewarding levels and quantity of play; a check cashing system 84; a manual input system 85 whereby monies may be requested (withdrawn) from, or deposited (credited) to, the transaction and information database 13; a food and beverage point of sale 86 device, or other retail point of sale device; or the like. The computer 120 of such an optional embodiment communicates, such as through a computer network, with a cash dispenser. The cash dispenser includes a cash safe 87 and a cash drawer 88 which may remove funds from a cash drawer 88, to be distributed to a customer or patron 89. Upon certain stored conditions, the computer 120 prompts the cash safe 87 to transfer cash to the cash drawer 88. Examples of such conditions include the depletion of cash from the cash drawer 88 through transactions (as described in greater detail below) to a level below a predetermined balance; a shift change at a location with fixed shift changes; or the like.

According to the present invention, transaction input, including a transaction amount, is received at the transaction nodes 250. The computer processor 120 collects the transaction input, stores the transaction input at the transaction and information database, and commands the cash drawer 88 to dispense cash to the patron 89. That is, upon request from the customer/patron 89, and upon establishing that the transaction and information database 13 indicates that the requested funds are available, the cash drawer 88 may dispense the requested cash to the customer/patron 89.

As noted above, the dispensing of cash may cause the amount of cash in the cash drawer 88 to fall below a certain level. If the level falls below a predetermined balance, the computer 120 commands the cash safe 87 to replenish the cash drawer 88. In an optional embodiment, the replenishment is recorded at the transaction and information database stored at the data storage 200 and the balance is zeroed (indicating that the cash drawer contains a predetermined amount of cash). Additionally or alternatively, the cash drawer 88 may be replenished from the cash safe 87 at a predetermined time criteria, such as a shift end, upon command from the computer 120.

In a further optional embodiment, an auditing and reporting system may be provided. In such an optional embodiment, the auditing and reporting functions may be performed by the same computer 120 as the cash handling functions, or may be separately handled. In either case, the auditing and reporting system may include an output device, such as a printer, so that data received through the computer network identifying, for each transaction input, the transaction node at which the transaction input was received and the transaction amount, may be output, e.g. printed as a report.

According to the optional embodiment illustrated in FIG. 9, the computer 120 may also perform player tracking functions, although it is also contemplated that the player tracking functions and cash handling functions may be separated. In an embodiment in which the fob 107 is used, a tag identifier received from the fob may be included in the transaction input. The tag identifier may be compared to a tag identifier database accessible to the computer 120 to validate the transaction.

While certain embodiments of the present invention have been shown and described it is to be understood that the present invention is subject to many modifications and changes without departing from the spirit and scope of the claims presented herein.

1. A cash reconciliation and secure cash replenishment system, comprising:
a computer storing a transaction and information database, said computer including a communications device for communicating with a computer network;
a cash dispenser communicating with said computer network, comprising:
a secure cash safe storing cash; and
a cash drawer receiving cash from said secure cash safe and dispensing cash; and
a plurality of transaction nodes receiving transaction input identifying a transaction amount, each transaction node communicating with said computer network such that transaction input received at one of said transaction nodes is transmitted to said computer for recording at said transaction and information database and triggers the dispensing of cash from said cash dispenser in accordance with said transaction input.

2. The system of claim 1 wherein said transaction input is received at said transaction nodes in the form of one or more of: (a) a manual input for manually entering transactions against said transaction and information database, (b) an electronic input for entering electronic transactions against said transaction and information database, (c) a computer input for entering electronic transactions against said transaction and information database through a point of sale system, (d) a computer input for entering electronic transactions against said transaction and information database through an electronic check cashing system, (e) a computer input for entering electronic transactions against said transaction and information database through a credit card system, (f) a computer input for entering electronic transactions against said transaction and information database through a debit card system, (g) a computer input for entering electronic transactions against said transaction and information database through a credit marker system, (h) a computer input for entering electronic transactions against said transaction and information database through an online accounting system, (i) a computer input for entering electronic transactions against said transaction and information database through a radio frequency identifier device, and (j) a computer input for entering manual transactions against said transaction and information database through an interface.

3. The system of claim 1 wherein said computer stores the conditions under which the computer triggers the transfer of cash from the cash safe to the cash drawer.

4. The system of claim 3 wherein at least one of said conditions is a specific time.

5. The system of claim 4 operated at a casino using fixed employee shift change times, wherein at least one of said conditions is said employee shift change times.

6. The system of claim 3 wherein at least one of said conditions is the depletion of cash in said cash drawer below a predetermined balance as determined by the accumulation of transactions stored at said transaction and information database.

7. The system of claim 1 further comprising an auditing and reporting system communicating with said computer network, said auditing and reporting system including an output device, said auditing and reporting system receiving data from said computer network identifying, for each transaction input, the transaction node at which the transaction input was received and the transaction amount and outputting said data at said output device.

8. The system of claim 1 wherein said computer stores a tag identifier database and each transaction input includes a tag identifier, such that before triggering the dispensing of cash at said cash dispenser, said computer validates said transaction input by comparing said tag identifier to said tag identifier database.
